(19) United States
(12) Patent Application Publication
(10) Pub. No.: US 2014/0351904 A1
(43) Pub. Date: Nov. 27, 2014

(54) METHOD FOR PAIRING ELECTRONIC APPARATUSES

(71) Applicant: Compagnie Industrielle et Financiere D'Ingenierie "Ingenico", Paris (FR)

(72) Inventors: Thierry Marsaud, Talence (FR); Michael Menardais, Saint Medard en Jalles (FR)

(73) Assignee: Compagnie Industrielle et Financiere D'Ingenierie "Ingenico", Paris (FR)

(21) Appl. No.: 14/368,177

(22) PCT Filed: Dec. 24, 2012
(86) PCT No.: PCT/EP2012/076885

§ 371 Date: Jun. 23, 2014

(30) Foreign Application Priority Data
Dec. 23, 2011 (FR) 1162408

(51) Int. Cl. H04L 29/06

(52) U.S. Cl. CPC H04L 63/08
USPC 726/5

(57) ABSTRACT

A method of pairing a first item of equipment, termed an initiating equipment desiring to transmit and receive data with a second item of equipment, termed an accepting equipment. The method includes: generating a pairing code; restoring, in the form of a first symbol, the paring code by the accepting equipment; acquiring the first symbol by the initiating equipment; and decoding the first symbol acquired delivering the pairing code.

### 1. FIELD OF THE INVENTION

The invention pertains to the field of authentication. The invention pertains more particularly to the hardware authentication of devices relative to one another.

### 2. PRIOR ART

There are numerous protocols well known in the prior art enabling two devices to first get authenticated before making transmission or exchanging confidential information. This is the case, for example, of a wireless communications terminal that seeks to get authenticated with a user's local-area network, for example a WiFi wireless network. To this end, before exchanging any data, the terminal must first get authenticated with the communications network. This authentication is generally done through a phase of entering a key, for example a WEP (Wired Equivalent Privacy) key, a WPA (Wi-Fi Protected Access) key, a PSK (pre-shared key) or the like. One of the problems with this type of key is its length. A WEP key comprises 13 characters while a WPA-PSK key is normally a secret phrase that can be lengthy to enter.

Other fields require authentication between wireless devices. This is the case for example with devices that communicate by means of Bluetooth® technology. Bluetooth is a wireless technology for the creation of wireless personal-area networks working in the 2.4 GHz frequency band which does not require authorization, with a range of about 10 meters. The networks are generally formed by nomad peripherals such as cell phones, personal digital assistants and laptops. By default, a Bluetooth communication is not authenticated and any peripheral can exchange data with any other peripheral whatsoever.

A Bluetooth peripheral (for example a cell phone) can choose to request authentication in order to provide a particular service. Bluetooth authentication is generally done with PIN codes. A Bluetooth PIN code is an ASCII string with a maximum length of 16 characters. By default, the user must enter the same PIN code on both peripherals. Once the user has entered the PIN code, the two peripherals generate a link key. Then, this link key can be recorded either in the peripherals themselves or on an external storage means. During the following exchange, the two peripherals will use the previously generated link key. This procedure is called coupling. When the link key is lost by one of the peripherals, the coupling operation has to be repeated so that a new key can be generated.

When the pieces of data that has to be exchanged between the two Bluetooth terminals are sensitive (bank data for example), the exchanges that follow the coupling phase are encrypted, for example by means of the E0 algorithm. E0 is the stream encryption algorithm used to protect the confidentiality of data exchanged in the Bluetooth system.

The problem however is the same as it is for the WEP key or the WPA key: prior to any encrypted exchange, the user must first enter a PIN code into the terminal, the length of this PIN code varying from 4 to 16 characters, given that for the most secured applications, it is the 16-character PIN code that is preferred.

Whether it is for WiFi technology or for Bluetooth technology, the entry of a PIN code or of an excessively lengthy key leads to at least two problems:
on the one hand, there is a high risk of error during the entry. Indeed, it is almost certain that the entry will comprise at least one error. This is especially true when the entry is made is done with masked characters (the characters entered are not displayed but instead there is a sequence of asterisks displayed);
on the other hand, since the entry is done by hand, there is no certainty that a malicious person might not snoop on the entry operation in order to appropriate the PIN code or the key for fraudulent use.

Securing solutions have been proposed, chiefly in order to implement a WiFi connection. They consist of the almost simultaneous activation of two devices to be connected together. One of these approaches is known as “a WiFi protected set up (WPS)” and is a wireless local-area network standard that is simple and secure. This solution however does not settle every problem since one of the variants of WPS assumes the entry of a PIN code.

In other words, it is necessary to provide a connection solution that is both simple and discreet in order on the one hand to avoid entry errors and on the other hand to ensure the confidentiality of the data needed for the connection or the pairing.

### 3. SUMMARY OF THE INVENTION

The invention does not have these drawbacks of the prior art. The invention relates to a method for pairing a first apparatus called an initiating apparatus with a second apparatus called an accepting apparatus, said initiating apparatus seeking to transmit and receive data to and from said accepting apparatus.

According to the invention, said method comprises:
a step for generating a pairing code;
a step for the rendering, in the form of a first symbol, of said pairing code by said accepting apparatus;
a step for the acquiring of said first symbol by said initiating apparatus;
a step for decoding said first acquired symbol delivering said pairing code.

According to the invention, the pairing code is random and volatile. It is not stored and cannot be retrieved subsequently.

According to one particular characteristic, said pairing method furthermore comprises:
a step for the obtaining, by said accepting apparatus, of at least one piece of payload data;
a step for the rendering, in the form of a second symbol, of said at least one piece of payload data.

According to one particular characteristic, said pairing method furthermore comprises:
a step for the acquiring of said second symbol by said initiating apparatus;
a step for decoding said second symbol delivering said pieces of payload data.

According to one particular characteristic, said first symbol and said second symbol form one and the same symbol.

According to one particular embodiment, a symbol belongs to a type of symbol and said type of symbol belongs to the group comprising:
a one-dimensional barcode;
a two-dimensional barcode;
a watermarked image;
a modulated sound sequence.

According to one particular characteristic, said initiating apparatus is a PDA and said accepting apparatus is a payment terminal.

According to one particular characteristic, said step for rendering said pairing code in the form of a first symbol comprises a step for printing out said first symbol on a printer of said accepting apparatus.

According to one particular embodiment, said step for acquiring said first symbol by means of said initiating apparatus comprises a step for acquiring an image representing said first symbol.

The invention also pertains to an initiating apparatus seeking to transmit and receive data to and from an accepting apparatus.

According to the invention, such an apparatus comprises:
means for acquiring a first symbol representing a pairing code enabling the pairing of said accepting apparatus and said initiating apparatus, said first symbol being rendered by an accepting apparatus;
means for decoding said first acquired symbol delivering said pairing code.

The invention also pertains to an accepting apparatus seeking to transmit and receive data to and from an initiating apparatus. According to the invention, such an apparatus comprises:
means for generating a pairing code enabling the pairing of said accepting apparatus and said initiating apparatus;
means for rendering said pairing code in the form of a first symbol.

The invention is also aimed at providing an information carrier readable by a data processor and comprising instructions of a program as mentioned here above.

The information carrier can be any entity or device whatsoever capable of storing the program. For example, the carrier can comprise a storage means such as a ROM, for example a CD-ROM or a microelectronic circuit ROM or again a magnetic recording means such as a floppy disk or a hard disk drive.

Furthermore, the information carrier can be a transmissible carrier such as an electrical or optical signal which can be conveyed via an electrical or optical cable by radio or by other means. The program according to the invention can be especially uploaded to an Internet type network.

As an alternative, the information carrier can be an integrated circuit into which the program is incorporated, the circuit being adapted to executing or being used in the execution of the method in question.

According to one embodiment, the invention is implemented by means of software and/or hardware components. In this respect, the term “module” may correspond in this document equally well to a software component and to a hardware component or to a set of hardware and software components.

A software component corresponds to one or more computer programs, one or more sub-programs of a program or more generally to any element of a program or a piece of software capable of implementing a function or a set of functions as described here above for the module concerned. Such a software component is executed by a data processor of a physical entity (terminal, server, etc) and is capable of accessing hardware resources of this physical entity (memories, recording media, communications buses, input/output electronic boards, user interfaces, etc).

In the same way, a hardware component corresponds to any element of a hardware unit capable of implementing a function or a set of functions as described here above for the module concerned. It can be a programmable hardware component or a component with an integrated processor for the execution of software, for example an integrated circuit, a smartcard, a memory card, an electronic board for the execution of firmware, etc.

### 4. FIGURES

Other characteristics and advantages of the invention shall appear more clearly from the following description of a preferred embodiment, given by way of a simple, illustratory and non-exhaustive example, and from the appended drawings, of which:

FIG. 1 describes the general principle of the invention;

FIG. 2 describes the steps needed for pairing a PDA with a payment terminal;

FIG. 3 symbolizes an accepting apparatus according to the invention;

FIG. 4 symbolizes an initiating apparatus according to the invention.

### 5. DESCRIPTION OF ONE EMBODIMENT

### 5.1. Reminder of the Principle of the Invention

As explained here above, the invention offers a novel method of entry of a pairing code (for example a PIN code) for the matching of two devices. The invention can also be applied especially to the Bluetooth pairing technology but it is also possible to apply it to other protocols which comprise an entry, by the user, of a PIN code or a password or a “passphrase” (a secret sentence used for better security than that provided by a simple password).

In one particular embodiment, which shall be described here below, the solution of the invention implements two Bluetooth apparatuses, one that initiates the process of pairing and the other that accepts it.

Here below, the terms “initiating apparatus” and “receiving apparatus” shall be used to designate these two apparatuses respectively.

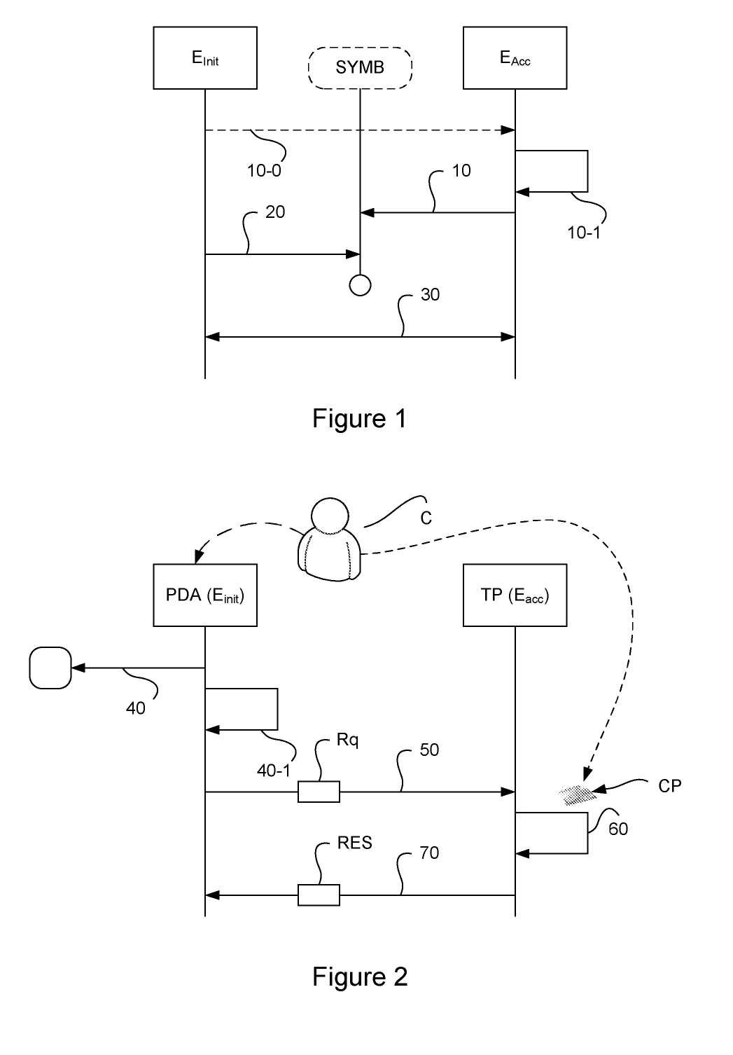

The method of the invention is described with reference to FIG. 1. In the framework of the invention, the initiating apparatus E_{Init} has an electronic image sensor (such as for example a code reader, a barcode reader, a peripheral enabling the reading and the decoding of images such as photographic cameras embedded in Smartphones or other electronic apparatuses) and the accepting apparatus E_{Acc} has a printer or a screen and must be capable of printing or displaying the symbols (the accepting apparatus more generally has a means of visual or sonic rendering).

The term “symbol” used herein is understood to mean any type of representation of a piece of digital or alphanumerical data in the form of a graphic or audio symbol (examples are: 1D, 2D or 3D barcodes, sound pulses, etc). According to the invention, the symbol comprises a set of data that can be rendered by the acquiring apparatus and acquired by the initiating apparatus. According to the invention, the symbol cannot be interpreted by a human being (it is not directly readable and understandable or audible and understandable). In one specific embodiment of the invention, the symbol is overlaid on an image according to a watermarking method (this is a watermarked image). In this embodiment, the initiating apparatus acquires the image and obtains the mark concealed in the acquired image. From this mark, it recreates the symbol and decodes to it obtain the PIN code. There is therefore a dual encoding of the PIN code. This is advantageous from several points of view. On the one hand, the fact that the symbol is concealed in a watermarked image prevents a fraudster from perceiving that the image displayed contains a code. On the other hand, to obtain the concealed mark, it is necessary to implement a method of discovery (of decoding) of the symbol, and this actually constitutes a dual encoding and increases security. Advantageously, the image used to insert the symbol is for example the logo of the store or bank or entity that uses the terminals. Thus, it becomes even more complicated for any person to find out that a symbol has been sent. In the case of a sound sequence, the advantages produced are similar. Firstly, this is because the sequence is produced at the initiative of the first terminal and because a fraudster therefore does not know when it is produced. Secondly, as in the case of the watermarked image, this is because the sound sequence again represents an encoding of the symbol and it is therefore necessary to carry out a dual decoding to obtain the information. Thirdly, the modulated sound sequence can be sent on frequencies imperceptible to a fraudster, so that he cannot know when the code is sent. Depending on the embodiments, the modulated sound sequence could for example be a DTMF sequence. Thus, in the context of the invention, there are several types of symbols that can be used. As shall be presented here below, the different types of symbols can be used jointly or successively.

According to the invention, the pairing process is done overall in two steps for the user:
the accepting apparatus E_{Acc}, renders 10 (prints or displays or sends as sound) the symbols SYMB of the PIN code. As a complement, other parameters can also be rendered (address of the accepting apparatus for example, this aspect is described in detail here below);
the initiating apparatus E_{Init} acquires 20 (by reading, scanning or audio recognition) the PIN code by means of the symbol reader. When other parameters are used (the address of the accepting apparatus for example), this address is also acquired.

There is therefore no entry by hand on the part of the user, and this simplifies the process and prevents errors.

The standard pairing mechanism with authentication is therefore initiated 30 and the two apparatuses get connected in a few seconds (depending on the radio environment).

The PIN code is generated 10-1 randomly on the accepting apparatus and is formed by as many characters as possible, thus ensuring a high level of security in the link between the two apparatuses. In the case of an application using Bluetooth technology for example, the PIN code comprises 16 characters.

In addition, the PIN code is generated asynchronously, before or after the decision 10-0 for pairing the initiating apparatus E_{Init} with the accepting apparatus E_{Acc} and is therefore not stored in a non-volatile memory in the accepting apparatus E_{Acc}. The decision 10-0 is taken by a user who decides to pair the two apparatuses. The PIN code is random and volatile.

When two apparatuses are already matched, it is possible also to set up a new pairing with a new random PIN code. This enables the encryption key to be modified periodically and therefore further increases the security of this link.

As explained earlier, the initiating apparatus E_{Init} can be provided with not only the PIN code but also other payload data that can be taken into account to increase the level of security of the proposed method. Depending on the embodiments, these pieces of payload data can be obligatory for the validation of the pairing process.

An example that can be cited of these other pieces of payload data is the address (for example the Bluetooth address) of the accepting device E_{Acc}. Depending on the embodiments of the invention, the providing of these pieces of payload data can be done differently.

In a first embodiment, the providing of the payload data is separated from the providing of the PIN code. This means that, subsequently to the acquisition of the symbol representing the PIN code by the initiating apparatus E_{Init}, a second step of acquisition takes place. This separation into two steps ensures compliance with the procedure and therefore offers additional securing. Naturally, these pieces of payload data are also presented in symbol form which can be of a type different from that of the first symbol. Thus, for example, the first symbol can be a one-dimensional barcode while the second symbol can take the form of a two-dimensional barcode.

In a second embodiment, the payload data can be provided jointly with the PIN code in symbol form. This providing of the data and the PIN code jointly can be done in one and the same symbol, for example a one-dimensional or two-dimensional barcode or else by using two different types of symbols (the first symbol can be a one-dimensional barcode while the second symbol can take the form of a two-dimensional barcode). The difference between this second embodiment and the first embodiment is made when acquiring the symbols. Presenting the payload data jointly with the PIN code but in a symbol distinct from the symbol of the PIN code makes profitable use of the capacity of novel scanners to scan several barcodes simultaneously.

### 5.2. Description of One Particular Embodiment

In this embodiment, a description is provided of the implementation of the invention for the pairing of two devices by means of Bluetooth technology: a PDA and a payment terminal are paired. In this embodiment, the PDA is the initiating apparatus and the payment terminal is the accepting apparatus.

As compared with the difficulties and problems mentioned here above, the pairing of a payment terminal has yet other difficulties, among them the obligation to ensure a level of absolute confidentiality of the data transmitted to the terminal.

Indeed, one of the functions that underlie the pairing of a payment terminal with a PDA is the payment function. This function is described briefly with reference to FIG. 2. Once the payment terminal and the PDA have been paired (by the method which is the object of the invention), i.e. after the step 30 of FIG. 1, these two entities will exchange encrypted data, for example according to the following process:

A client C makes purchases in a shop using a PDA. He can either use the PDA alone for this purpose or it is the vendor who has the PDA. The PDA is used to scan 40 the articles purchased by the customer. To this end, the PDA uses an application known as a “business” application which is executed on the PDA. This scanning phase has to be understood in its broadest sense. It can be a barcode scan or a scan made with an optical sensor of a camera or a selection from a list of products presented on the screen of the PDA. This “scan” phase is repeated 40-1 as many times as the client wishes to purchase products or services.

When the customer has completed his purchases, the “business” application of the PDA requests payment for the purchases from the client C with the payment terminal TP. This request Rq is transmitted 50 by the PDA to the payment terminal TP by means of the Bluetooth link which has been preliminarily configured by the method that is the object of the invention. This encrypted request Rq comprises especially the amount of the transaction (among other parameters). This amount is retrieved by the payment terminal TP which uses it to initiate a transaction. In general, this transaction is done with a payment card CP in the user's possession. When the transaction 60 is initialized, the payment terminal takes over: this means that the business application which is launched on the PDA is placed in “pending” mode. The payment terminal TP alone controls the progress of the payment transaction. The customers thus makes payment by means of the payment terminal TP. When the payment is validated by the payment terminal TP (or when the transaction has failed), the payment terminal TP sends 70 the result RES of the transaction to the PDA (this is either a confirmation of payment or a notification of failure of the transaction), and the business application installed in the PDA resumes control to finalize the purchase. This finalizing operation, depending on the business application, can consist in crediting loyalty points to a customer account, or verifying state of stocks, etc.

From the description that has just been made, it will easily be understood that threats weighing on the exchanges of data between the PDA and the terminal must be controlled as efficiently as possible. It is thus indispensable to ensure a high level of security of the pairing process between the PDA and the payment terminal. It can indeed be understood that if, from the very outset, a hacker manages to procure the PIN code transmitted from the payment terminal to the PDA, the subsequent security of exchanges between these two apparatuses will be heavily compromised.

In this embodiment, the inventors have had the ingenious idea of using the functions that are integrated both into the payment terminal and into the PDA. More particularly, in this embodiment, the payment terminal has a printer and the PDA has an optical barcode scanner. Thus, rather than requesting the entry of a PIN code by the merchant, the inventors have proposed, in this embodiment, to randomly generate a PIN code in the payment terminal and then print the symbol representing this PIN code in the form of a barcode using the printer of the payment terminal. Once printed, this symbol in the form of a barcode is then scanned by the PDA by means of the appropriate scanning application and is interpreted by the PDA. The result of this interpretation (which is the PIN code generated by the payment terminal) is then provided to the Bluetooth module of the PDA so that it can complete the pairing procedure.

In this embodiment again, a second symbol is printed in the form of a barcode. It corresponds to the Bluetooth address of the payment terminal. This second barcode is also scanned by the PDA in the second phase and the Bluetooth address of the payment terminal is obtained. This enables authentication, in a unique way, of the terminal with which the PDA must be paired.

Thus, this method of the invention resolves both problems referred to here above, i.e. on the one hand the problem related to errors in entering very long strings of characters and, on the other hand, the problem related to the necessary confidentiality that must surround the PIN code entered.

The invention has been described in one particular embodiment. It is naturally clear that the invention is in no way limited to this embodiment. The invention also relates to apparatuses that enable the pairing as described here above. More particularly, the invention relates to an accepting apparatus. The accepting apparatus comprises, according to the invention: means for generating a pairing code in response to this pairing decision, means for rendering the pairing code in the form of a symbol. These rendering means, as indicated, can consist of a printer, a screen or a means of sound rendering.

All these means are driven by a computer program that is specifically adapted, according to an initial pairing protocol, to generating a pairing code, converting it into a symbol and rendering this symbol. The computer program furthermore comprises a phase of suspension of the pairing so long as the pairing procedure has not been completed in the initiating equipment.

The invention also relates to an initiating apparatus. The initiating apparatus comprises, according to the invention, means for obtaining a symbol of a pairing code in response to this pairing decision, means for decoding the acquired symbol delivering a pairing code or other payload data as a function of the symbol and its type. These means for obtaining can, as already indicated, consist of an optical sensor, a camera, a microphone.

All these means are driven by a computer program specifically adapted, according to an initial pairing protocol, to obtaining one or more symbols, decoding it into a pairing code and implementing the subsequent pairing. The computer program furthermore comprises a phase of suspension of the pairing so long as the pairing procedure has not been completed in the accepting apparatus.

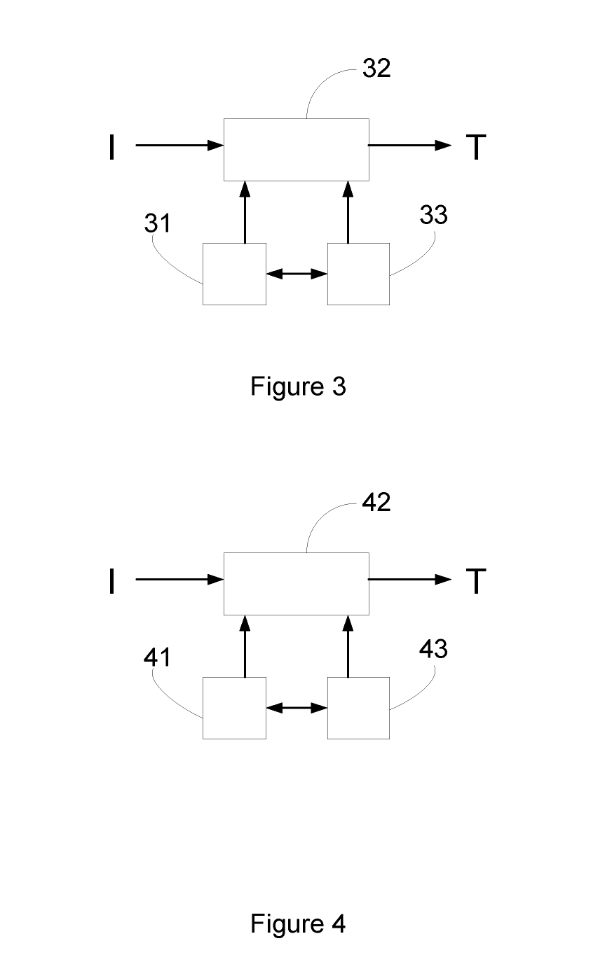

Referring to FIG. 3, we present an embodiment of an accepting apparatus according to the invention.

Such an accepting apparatus comprises a memory 31 constituted by a buffer memory, a processing unit 32, equipped for example with a microprocessor P and driven by the computer program 33 implementing the method of modification according to the invention.

At initialization, the code instruction of the computer program 33 are for example loaded into a RAM and then executed by the processor of the processing unit 32. The processing unit 32 inputs at least one piece of information I such as a pairing decision. The microprocessor of the processing unit 32 implements the steps of the pairing method described here above according to the instructions of the computer program 33 to deliver a piece of processed information T such as the symbol or symbols needed for the pairing of the equipment. To this end, the apparatus comprises, in addition to the buffer memory 31, the means described here above. The means are driven by the microprocessor of the processing unit 32.

Referring to FIG. 4, we present an embodiment of an initiating apparatus according to the invention.

Such a device comprises a memory 41 constituted by a buffer memory, a processing unit 42, equipped for example with a microprocessor P and driven by the computer program 43, implementing the pairing method according to the invention.

At initialization, the code instruction of the computer program 43 are for example loaded into a RAM and then executed by the processor of the processing unit 42. The processing unit 42 inputs at least one piece of information I such as a symbol coming from an accepting apparatus. The microprocessor of the processing unit 42 implements the steps of the method for modifying described here above, according to the instructions of the computer program 43, to deliver a piece of processed information T such as the pairing code. To this end, the apparatus comprises, in addition to the buffer memory 41, the means described here above. The means are driven by the microprocessor of the processing unit 42

As has been perfectly understood, the pairing method as described here above comprises in fact a first sub-method for pairing which is implemented on the initiating terminal and a second sub-method for pairing which is implemented on the accepting terminal.

1. A method for pairing a first apparatus called an initiating apparatus, with a second apparatus called an accepting apparatus, said initiating apparatus seeking to transmit and receive data to and from said accepting apparatus, said method comprising:
generating a pairing code;
rendering, in the form of a first symbol, said pairing code by said accepting apparatus;
acquiring said first symbol by said initiating apparatus;
decoding said first acquired symbol delivering said pairing code,
wherein the first symbol belongs to a type of symbol belonging to the group consisting of:
a watermarked image;
a modulated sound sequence.

2. The method for pairing according to claim 1, wherein the method further comprises:
obtaining, by said accepting apparatus, at least one piece of payload data; and
rendering, in the form of a second symbol, said at least one piece of payload data.

3. The method for pairing according to claim 2, wherein the method further comprises:
acquiring said second symbol by said initiating apparatus; and
decoding said second symbol delivering said pieces of payload data.

4. The method for pairing according to claim 3, wherein said first symbol and said second symbol form one and the same symbol.

5. The method for pairing according to claim 1, wherein said initiating apparatus is a PDA and said accepting apparatus is a payment terminal.

6. The method according to claim 1, wherein rendering said pairing code in the form of the first symbol comprises printing out said first symbol on a printer of said accepting apparatus.

7. The method according to claim 6, wherein acquiring said first symbol by said initiating apparatus comprises a step for acquiring an image representing said first symbol.

8. An initiating apparatus seeking to transmit and receive data to and from an accepting apparatus, comprising:
means for acquiring a first symbol representing a pairing code enabling pairing of said accepting apparatus and said initiating apparatus, said first symbol being rendered by the accepting apparatus;
means for decoding said first acquired symbol delivering said pairing code, wherein the first symbol belongs to a type of symbol belonging to the group consisting of:
a watermarked image;
a modulated sound sequence.

9. An accepting apparatus seeking to transmit and receive data to and from an initiating apparatus, comprising:
means for generating a pairing code enabling the pairing of said accepting apparatus and said initiating apparatus;
means for rendering said pairing code in the form of a first symbol, wherein the first symbol belongs to a type of symbol belonging to the group consisting of:
a watermarked image;
a modulated sound sequence.
